(19) United States
(12) Patent Application Publication
(10) Pub. No.: US 2017/0198462 A1
(43) Pub. Date: Jul. 13, 2017

(54) SHARP FIXTURES

(71) Applicant: Bobby Sharp, Memphis, TN (US)

(72) Inventor: Bobby Sharp, Memphis, TN (US)

(21) Appl. No.: 15/415,548

(22) Filed: Jan. 25, 2017

Related U.S. Application Data
(60) Provisional application No. 62/278,026, filed on Jan. 13, 2016.

(51) Int. Cl. E03C 1/18; C21D 9/00; C04B 41/50; C04B 41/00; C04B 41/86; C22F 1/08; C03B 32/00

(52) U.S. Cl. CPC E03C 1/18; C22F 1/08; C21D 9/0068; C03B 32/00; C04B 41/0072; C04B 41/86; C04B 41/5022

(57) ABSTRACT

The present invention relates to a decorative ceramic or vitreous sink customized with unique designs, themes, logos, pictures, stamps, etc and the manufacturing method of the same. The decorative ceramic or vitreous sink can be used as a personalized fixture in home or as a medium for advertisement and commercialization by way of descriptive images and logos imprinted on the surface of the sink. The material is heated at 200° F. for two hours first, then at 300° F. for two hours and finally at 300 to 400° F. for two hours.

### CROSS REFERENCE TO RELATED APPLICATIONS

This application claims the priority of U.S. application 62/278,026, filed on Jan. 13, 2016, the disclosure of which is expressly incorporated by reference herein

### FEDERALLY SPONSORED RESEARCH AND DEVELOPMENT

Not applicable.

### MICROFICHE

Not applicable

### BACKGROUND OF THE INVENTION

Field of the Invention

The present invention relates to sinks, and more particularly to a decorative sink.

Background of the Invention

Sinks and washbasins are basic household equipment seen very commonly in houses, schools, hospitals, work stations, restaurants, etc. and used for various purposes like washing hands and face, brushing teeth, washing dishes in kitchen, etc. With time there have been many modifications in the construction and design of these sanitary fittings, from being heavy weight to light weight, fragile to tough or durable and various shapes too.

Sinks made up of stainless steel are very common in kitchens to resist damage from cold and hot water. Similarly, stone and ceramic washbasins are commonly seen in bathrooms. Variations are also seen in styles, shapes and rims of these sinks and washbasins. A number of different types of sinks and wash basins are available in the prior art. For example;

U.S. Pat. No. 8,239,981 B2 to Schott Vtf shows a glass or ceramic glass wash basin comprising one part that forms water receptacle, one part that prevents the water from flowing from water receptacle, a water drainage hole, and the aforementioned first part is equipped with a groove for receiving the lower edge of the second part.

EP Pat. No. EP1422352 A2 to CARL-ZEISS-STIFTUNG, Schott Glas shows a bowl-like-flangeless designed basin body with an LED illumination device positioned on it.

U.S. Pat. No. USD332828 S to Jean-Pierre Schaerrer shows a washbasin comprising drain hole and grooves for faucet and one end of the washbasin is cut semi-circularly.

U.S. Pat. No. USD320846 S to B. C. Sanitan Limited shows a washbasin that is somewhat circular in design.

None of the above inventions and patents, taken either singly or in combination, is seen to disclose a wash basin or sink that is provided with themes and images printed on it.

### SUMMARY OF THE INVENTION

In view of the foregoing disadvantages inherent in the known types of sinks present in the prior art, the present invention provides a decorative sink to be used as sanitary fixture indoor and outdoor. As such, the general purpose of the present invention, which will be described subsequently in greater detail, is to provide a new and improved decorative sink which can be customized as per customer's preference.

It is primary object of the invention to provide a decorative sink for sanitary fixture personalized with desired themes and images.

Another objective of the present invention is to provide a decorative sink ideal for home, offices, schools or restaurants.

Yet another objective of the present invention is to provide a decorative sink to increase the beauty and elegance of areas where they are mounted.

Yet another objective of the present invention is to provide decorative sink that is available in different sizes, designs, colors and themes as per the requirement of customer.

In yet another embodiment of the present invention, a method of manufacturing a decorative sink is provided. The method includes: (i) drying a material till shrinkage of 4% to 15% occurs, (ii) heating said material at very low heat, (iii) heating said material at medium heat, (iv) heating said material at high heat, (v) warming up of the material, (vi) closing the opened doors and dampers, (vii) heating at low ramp, (viii) bringing a kiln to medium heating setting for two hours, (ix) bringing interior of said kiln at red heat, (x) shutting off said kiln, when target cone is bent at 90° angle, (xi) bone drying said material when placed into said kiln, (xii) heating said material slowly up to boiling point of water, (xiii) raising kiln temperature, (xiv) treating said material at about 1730° F. (945° C.), (xiv) maturation of said material, and (xv) performing glazing on said material. The very low heating occurs at a temperature of 200° F. for two hours. The medium heating occurs at a temperature of 300° F. for two hours. The high heating occurs at a temperature of 300 to 400° F. for two hours.

The summary is provided to introduce a selection of concepts, in a simplified form, that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 illustrates a top view of a decorative sink according to an embodiment herein;

FIG. 2 illustrates an isometric view of the decorative sink of FIG. 1 according to an embodiment herein; and

FIG. 3A illustrates a continued flow diagram of the manufacturing process of the decorative sink of FIG. 1 according to an embodiment herein continued in FIG. 3B and FIG. 3C.

### DETAILED DESCRIPTION OF THE INVENTION

The following is a detailed description of example embodiments of the invention that is depicted in the accompanying drawings. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

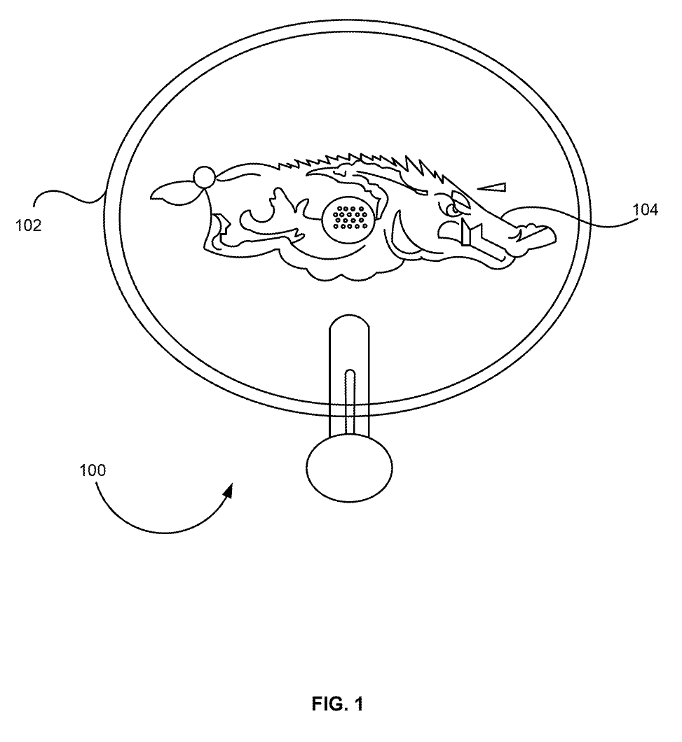

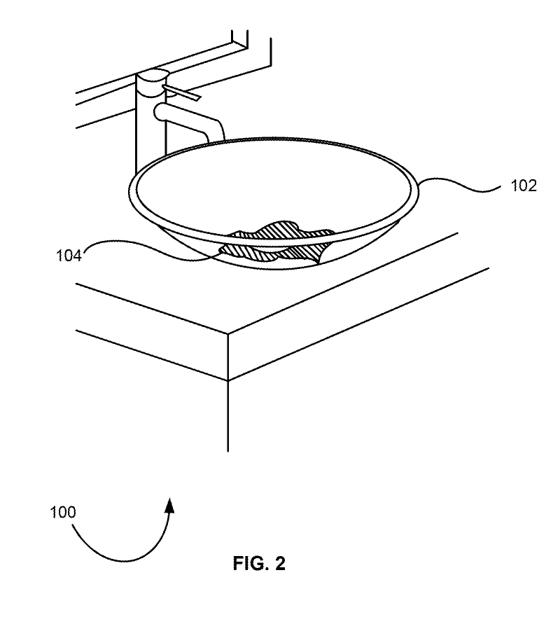

As mentioned, there remains a need of a decorative sink. The embodiments herein achieve this by providing a sink. Referring now to the drawings, and more particularly to FIGS. 1 through 2, where similar reference characters denote corresponding features consistently throughout the figures, there are shown preferred embodiments.

FIG. 1 of the present invention illustrates a top view of a decorative sink 100 according to an embodiment herein. The decorative sink 100 includes a sink 102 and an image 104 printed on a surface of the sink 102. The surface of the sink 102 includes the image 104 which may be infused, integrated or impregnated within/into the surface of the sink 100 to customize it as per requirement of a user.

FIG. 2 shows an isometric view of the decorative sink 100, according to an embodiment herein. In one embodiment, the surface of the sink 100 is customized with images, including without limiting, themes, designs, logos, stamps, pictures of landscapes, birds, animals, celebrity pictures and/or sports images.

In general, the present invention provides a decorative sink 100 to be mounted in places like kitchen, wash rooms, rest rooms, schools, offices, restaurants, stations, etc. for cleaning hands or face or washing dishes. The decorative sink 100 is customized as per the requirement of the customer to make it look fancy and attractive. The decorative sink 100 in the referred figures can be in fixed in houses to enhance the beauty and glam up the area where it is mounted. Apart from being ornamental in appearance, the decorative sink 100 provides personal enjoyment to user.

In accordance with various embodiments of the present invention the decorative sink 100 can be used as a medium for advertisement or commercialization of different products and services. For instance, the decorative sink 100 mounted in restaurants can be imprinted or painted with an image 104 of that particular restaurant as a way of commercialization. In another example, the rest rooms in public places can have decorative sink 100 with an image 104 advertising any cultural or sport event.

The decorative sink 100 can be of different size, weight, colors and designs. Shape of the decorative sink 100 can be from various shapes such as circular, square, rectangular, pentagon, hexagon, etc. The material for the sink 100 may be selected from a group of Vitreous, Copper and Stainless steel.

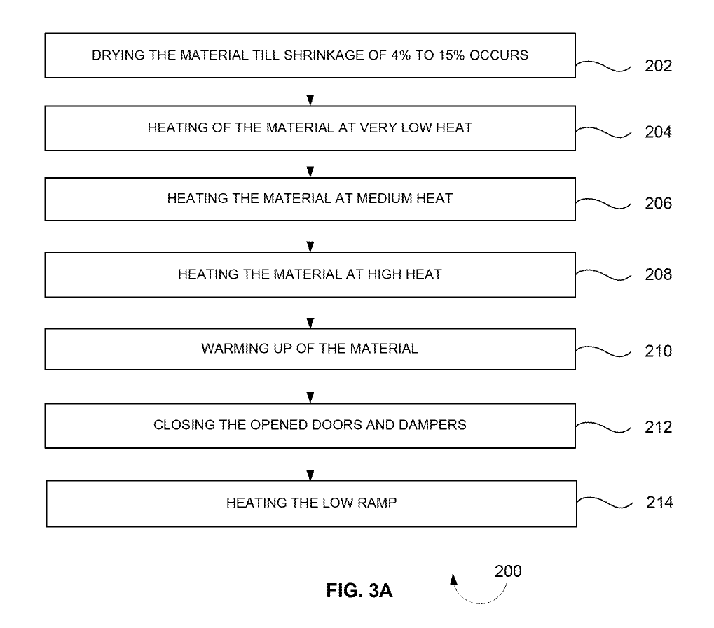

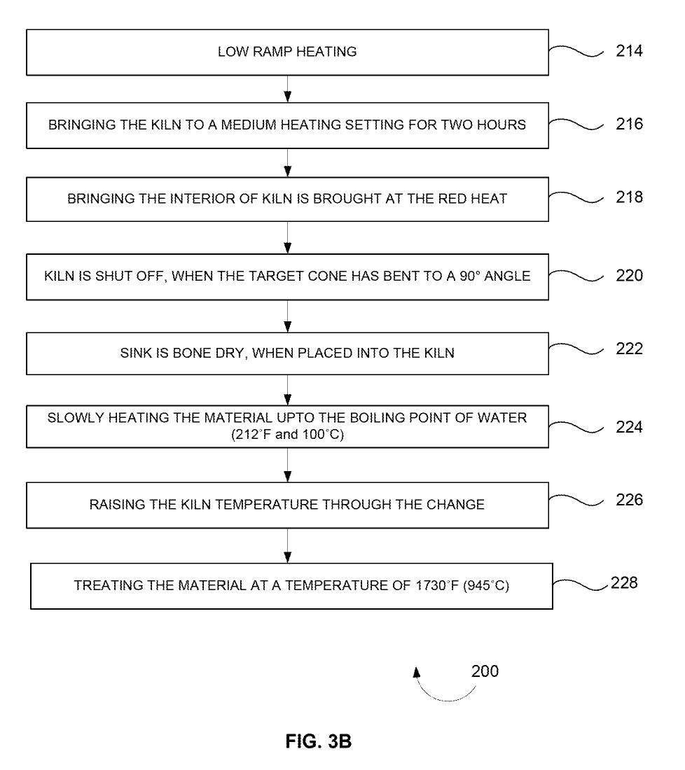

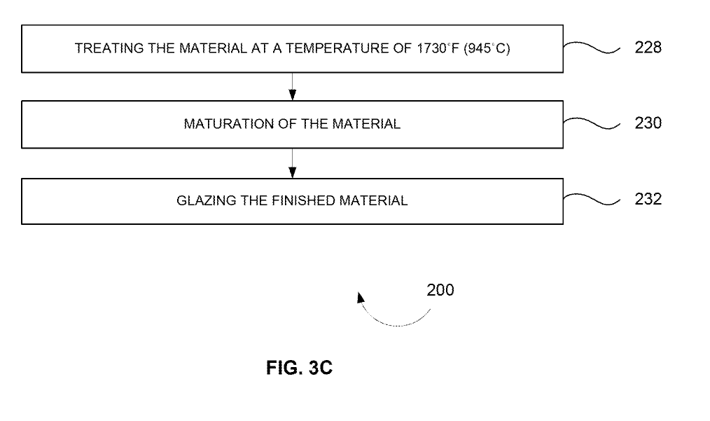

FIG. 3 illustrates an flow diagram of the manufacturing process 200 of the decorative sink 100 of FIG. 1 according to an embodiment herein continued in FIG. 3B and FIG. 3C. In another embodiment, when the material is wet and very pliable, the material contains a great deal of water. The material particles ride within water, which makes the material plastic, or easily workable. As the material dries, water evaporates, escaping from the spaces in between the particles. The particles move closer together, resulting in the entire pot shrinking. In another embodiment, the parameters of manufacturing the decorative sink 100 are adjusted based on the material slurry, ambient temperature and humidity. In other embodiment, the basic material used for manufacturing the sink 100 includes without limiting to clay, glass, ceramic, copper, stainless steel, cast iron and/or stone.

In step 202, the material is dried till shrinkage of 4% to 15% occurs. In another embodiment, the terms “firing schedule” and “firing ramp” are strongly related. Both refer to the rate at which the firing is done, including the heating, soaking period (if there is one), and cooling. The firing schedule for bisque firing is extremely important. For a bisque firing, there will be no soak, and the ramp (the increase in which the kiln's temperature is changing) should be very slow. The ramp rate is usually measured in degrees per hour. The correct firing temperatures for the material and glazes is the important aspect. Every kiln is unique but generally, the firing schedule should go in the sequence. In step 204, the material is heated overnight at very low heat and two hours at low heat (an increase in temperature of no more than 200° F. per hour). In step 206, the material is heated for two hours at medium heat (an increase in temperature of no more than 300° F. per hour). In step 208, the material is heated up to high heat (an increase in temperature of 300 to 400° F. per hour) until the required temperature has been reached.

In step 210, the warmup step of material includes: once the pots are finished, the pots are dried before being loaded into the kiln. In one embodiment, the kiln is selected from the group of without limiting to electric kiln, fuel fired kiln and an updraft kiln. For the electric kiln, if there is no controller, only the bottom-most element should be on with the lid open slightly and the spyholes open. For a fuel-fired kiln, begin with the pilots lit and the door and spyholes closed. For an updraft, close the damper completely; for a downdraft leave the damper just slightly open. In other embodiment, the temperature and burners of the kiln are continuously monitored.

In step 212, the open doors and dampers are closed and the heating energy is increased. In step 214, the material is brought to low ramp heat. In one embodiment. For an electric kiln with switches, all switches are turned to low. For a fuel-fired kiln, all the burners are brought to a low setting. In another embodiment, if the ware is thick-walled, the time of low ramp is increased to four or six hours, depending upon the thickness of the material. If any noise comes from the kiln such as popping sounds, the heat-energy needs to be lower down immediately. For the fuel fired kiln, the ramp is too steep and the ware is at peril. Make sure user wedge the material thoroughly when making the piece, so user don't have any air bubbles in the material that could crack in the firing process. The material should be free from any air bubbles to avoid any kind of crack in the firing process.

In step 216, the kiln is brought to a medium heating setting for two hours. In one embodiment, if the ware includes exceptionally thick walls, used can increase the time of medium ramp from four to six hours. In step 218, at the end of the medium ramp, the interior of the kiln is brought at the red heat. In one embodiment, for the average electric kiln, bisque temperature will generally be reached three to eight hours after the kiln goes on high. For a fuel-fired kiln, the cone packs needs to be checked every half hour. Once the first cone begins to tip, the cone needs to be checked every fifteen minutes. In step 220, when the target cone has bent to a 90° angle, the kiln is shut off After the kiln reaches the temperature, shut down all the heat sources. The openings are closed and the kiln is kept to cool at its own. In step 222, the sink is bone dry, when placed into the kiln.

The material is slowly heated to evaporate the left-over water trapped within the spaces between the material particles. In step 224, the material is heated up to the boiling point of water (212° F. and 100° C. at sea level), the material will lead to the compacting and some minimal shrinkage of the material.

The carbon, organic part, and sulphur of the material are burnt off between 572° and 1470° F. (300° and 800° C.). The material can also be characterized as being a molecule of alumina and two molecules of silica bonded with two molecules of water. Even after the atmospheric water is gone, the material still contains some 14% of chemically bonded water by weight. The pot will be substantially lighter, but with no physical shrinkage. In one embodiment, the chemically bonded water still left in the material. The chemically bonded water escapes from the material body at a temperature between 660° and 1470° F. (350° and 800° C.). At 1060° F. (573° C.), silica oxide changes its structure. In one embodiment, changes in the structure of silica oxide are known as inversions. The changes cause the increase in the size of pottery by 2%. In step 226, the kiln temperature is raised slowly through the change. Before the glass-making oxides begin to melt, the material particles are stick to each other. In one embodiment, the fusion of material particles are high temperature is also known as sintering process. The material is then subjected to the temperature of 1730° F. (945° C.). In step 228, the material is heated at 1730° F. (945° C.). In other embodiment, step 228 is known as bisque firing.

In step 230, the material is subjected to maturation. In one embodiment, the maturation step brings hardness and durability. In one embodiment, the maturation step lead to the formation of aluminum silicate. In other embodiment, the aluminum silicate is also known as mullite. The maturation of the material body is a balance between the vitrification of the body. In another embodiment, the vitrification is a gradual process during which the materials that melt most easily do so, dissolving and filling in the spaces between the more refractory particles. The melted materials promote further melting, as well as compacting and strengthening the body of the material. The mullite are long, needle-like crystals which acts as binders, knitting and strengthening the material body even further.

In one embodiment, the temperature of the material is fired to make a tremendous difference. If a material is fired at one temperature may be soft and porous, while that same material fired at a higher temperature may be hard and impervious. A porcelain body needs more temperature of about 2500° F. (1390° C.) to 3270° F. (1800° C.) to mature. In one embodiment, the ceramic glazes have a temperature range that they should be fired. If the glazes are fired at too low temperature, the glaze will not mature. If the temperature goes too high, the glaze will become too melted and run off the surface of the pottery. The firing ranges are a low-fire range, a mid-fire range, and a high-fire range. In one embodiment, two more ranges a very low-fire, and a lower mid-range firing ranges can be introduced along with the other firing ranges.

In step 232, the pmaterial is subjected to glazing. The possibilities with glazing are endless, and user can dip or paint on the glazes. The user can also use effects such as marbling, transfers or underglaze painting.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A decorative sink, wherein said decorative sink comprises:
a sink; and
an image, wherein said image is formed directly into a surface portion of said sink, such that said image is permanently infused into said surface portion of said sink.

2. The decorative sink of claim 1, wherein said image is selected from a group of themes, designs, logos, stamps, pictures of landscapes, birds, animals, celebrity pictures or sports images.

3. The decorative sink of claim 1, wherein said sink is made up of a material selected from glass, ceramic, copper, stainless steel, cast iron, stone or mixture thereof.

4. The decorative sink of claim 1, wherein said image is printed on said sink using paints that are made up of a material selected from epoxies, and enamels.

5. A method of manufacturing a decorative ceramic or vitreous sink, wherein said method comprises:
drying a material till shrinkage of 4% to 15% occurs;
heating said material at very low heat;
heating said material at medium heat;
heating said material at high heat;
warming up of the material;
closing the opened doors and dampers;
heating at low ramp;
bringing a kiln to medium heating setting for two hours;
bringing interior of said kiln at red heat;
shutting off said kiln, when target cone is bent at 90° angle;
bone drying said material when placed into said kiln;
heating said material slowly up to boiling point of water;
raising kiln temperature;
treating said material at about 1730° F. (945° C.);
maturation of said material; and
performing glazing on said material.

6. The method of manufacturing a decorative ceramic or vitreous sink of claim 5, wherein said very low heating occurs at a temperature of 200° F. for two hours.

7. The method of manufacturing a decorative sink of claim 5, wherein said medium heating occurs at a temperature of 300° F. for two hours.

8. The method of manufacturing a decorative ceramic or vitreous sink of claim 5, wherein said high heating occurs at a temperature of 300 to 400° F. for two hours.
